(19) United States
(12) Patent Application Publication
(10) Pub. No.: US 2024/0023497 A1
(43) Pub. Date: Jan. 25, 2024

(54) A VENTILATION SYSTEM PROVIDING HOMOGENOUS AIR DISTRIBUTION ONTO GRASS FIELD

(71) Applicant: Ismet Bülent KÖPRÜLÜ, Ümraniye, Istanbul (TR)

(72) Inventor: Ismet Bülent KÖPRÜLÜ, Ümraniye, Istanbul (TR)

(21) Appl. No.: 18/249,176

(22) PCT Filed: Nov. 11, 2020
(86) PCT No.: PCT/TR2020/051082

§ 371 Date: Apr. 14, 2023

(51) Int. Cl. A01G 13/08; A01G 20/30; F04D 25/16; F04D 29/60

(52) U.S. Cl. CPC A01G 13/08; A01G 20/30; F04D 25/166; F04D 29/601

(57) ABSTRACT

Disclosed is a ventilation system which provides for the removal of the air accumulated on the grass field surface from the grass by creating a sweeping effect by a fan in the playing fields such as stadiums with low air circulation and which provides the fresh air to be distributed onto the grass in a homogeneous manner. The distinctive feature of the ventilation system is that it lifts the fans providing the air circulation onto the field, that it can provide the air in a controlled manner without causing harm to the grass and facilitates the assembly and disassembly operation. In addition to that, it is mountable to an existing Growlight and/or artificial daylight unit.

### TECHNICAL FIELD

The invention is related to a ventilation system which provides air circulation on grass fields.

The invention, in particular, relates to a ventilation system which provides fresh air to be distributed homogenously onto the grass field, by replacing the air accumulating on the surface of the natural grass field, in stadiums covered from all four sided in which the air circulation is low.

### STATE OF THE ART

Today; there is a significant requirement of air circulation in football fields with natural grass surfaces. This air circulation requirement becomes a problem in arena type stadiums which are covered from all four sides and/or have covered roof, because the natural air circulation is very low.

In order to solve the problem of natural air circulation in the existing fields; fans (blowing devices) of certain sizes are placed at the edges of the fields. However, the fans in these applications blow the air inwards from the edge of the field with high pressure. In this case, the air breaks at a distance of 15-20 meters and loses its impact. Fans with higher motor power, which are used to carry the air into the further points of the field, cannot go beyond approximately 25 meters, either, and cannot function continuously and regularly because they cause drying up of the grass within the area of first 10 meters from the fan and turns into a system which is inefficient and with high electrical consumption.

In addition to the fact that the existing fans are unable have impact on the entire field and have high electrical consumption, they do not include a structuring which would facilitate the application of the liquids and gases required by the grass during the maintenance of the grass.

Patent application KR20180082434A was found in the literature survey on the state of the art. This document mentions a system which is placed underneath the grass field from the edges of the playing area with the purpose of cooling the grass layer. The document in question does not include a structuring which provides the circulation of the air which is accumulated on the grass and the distribution of the air in a homogenous manner.

Consequently, a development in the technical field is required due to the disadvantages mentioned above and the current applications being insufficient to solve these problems.

The Aim of the Invention

The invention aims to solve the disadvantages mentioned above by being created with the inspiration arising from the current status in the art.

The main aim of the invention is to remove the air accumulating on the grass field surface by creating a sweeping effect on the surface of the field in the stadiums, without drying up or damaging the grass. In this manner, it is ensured that the fresh air is distributed homogenously onto the grass surface.

Another aim of the invention is to create ventilation units by placing fans resistant to water, dust and moisture on a light conveyor system on wheels. By this means, it is aimed to displace the air accumulating on the grass by installing these ventilation units at certain intervals in the field.

Another aim of the invention is to provide a fan system which can be attached to the daylight units (Growlight units, UV devices, grass maintenance lamps, etc.) which are used in the fields in the current art.

Another aim of the invention is to facilitate the application of the liquids and gases which are required by the grass during the maintenance, by means of the pulverizator system which is attached to the fans.

In order to accomplish the aforementioned purposes, the invention is a ventilation system which provides for the removal of the air accumulating on the grass field surface from the grass by creating a sweeping effect by a fan in the playing such as stadiums with low air circulation and which provides the fresh air to be distributed onto the grass in a homogeneous manner, characterized by comprising at least one ventilation unit which provides the fans to be carried by suspension, a carrying trolley of the ventilation unit which comprises sufficient number of support struts, arms and wheels from which the fans are suspended and it can be made of materials such as steel, composite, aluminum etc. or a combination thereof, depending on the need. Depending on the required capacity, it is comprised of profile or truss system supports and sufficient number of arms and wheels.

The structural and characteristic features of the invention and all its advantages will be understood more clearly through the figures below and detailed descriptions with reference to these figures. Therefore, the evaluation should be made based on these figures and detailed descriptions.

### BRIEF DESCRIPTION OF DRAWINGS

FIG. 1, is a top perspective view of the ventilation system according to the present invention.

FIG. 2, is a general top view of the ventilation units and the ventilation system.

FIG. 3, shows alternative views of the ventilation system according to the present invention.

FIG. 4, is a close-up view of the fan on the ventilation system according to the present invention.

FIG. 5, is the folded view of the ventilation units.

### DESCRIPTION OF PART REFERENCES

1. Fan
10. Carrying trolley
   11. Towing arm
   12. Support strut
   13. Wheel
20. Ventilation unit
   21. Support beam
   22. Hinge
   23. Fan suspension bracket
   24. Fan connection fixture
   25. Pulverizator connection
   26. Fixture

### DETAILED DESCRIPTION OF THE INVENTION

In this detailed description, the preferred configurations of the ventilation system according to the present invention are described only for a better understanding of the subject matter.

The ventilation system according to the present invention aims to provide fresh air to be distributed homogenously onto the grass field, by replacing the air accumulating on the surface of the natural grass field, in stadiums covered from all four sides in which the air circulation is low. The ventilation system is fundamentally comprised of a fan (1), a carrying trolley (10), a ventilation unit (20) and a support strut (12) which serves as a carrier and support and a support beam (21).

The carrying trolley (10) enables the ventilation unit (20) from which the fans (1) are suspended to be mobile. Pushing, pulling and guiding of the said carrying trolley (10) and attaching the carrying trolley (10) onto a vehicle when needed is provided by the towing arm (11). The movement of the carrying trolley (10) by the said towing arm (11) is provided by the wheels (13) that are located under the carrying trolley (10). However, the operation of the fans (1) which are suspended from the ventilation unit serving as a support between the carrying trolley (10) and the ventilation unit (20), at a certain height from the field is provided by at least one support strut.

The ventilation unit (20) includes a support beam (21) which forms the frame, which is formed by a single profile or by a truss system and onto which the fans are mounted by suspension. In addition to that, it includes a hinge (22) which folds at the point where the support strut (12) and the support beam (21) are coupled to each other and enables the ventilation units (20) to occupy less space and therefore enables them to be stowed away or be carried easily.

The ventilation system according to the present invention includes a fan suspension bracket (23) which provides the space between the ventilation fans (1) and the support beams (21) and also enables the vertical orientation adjustment of the fans (1) and a fan connection fixture (24) which enables the ventilation fans (1) to be attached to any type of daylight units. It also includes a pulverizator connection (12) which enables the mounting of the pulverizators, which provide the application of various liquids and gases required by the natural grass field.

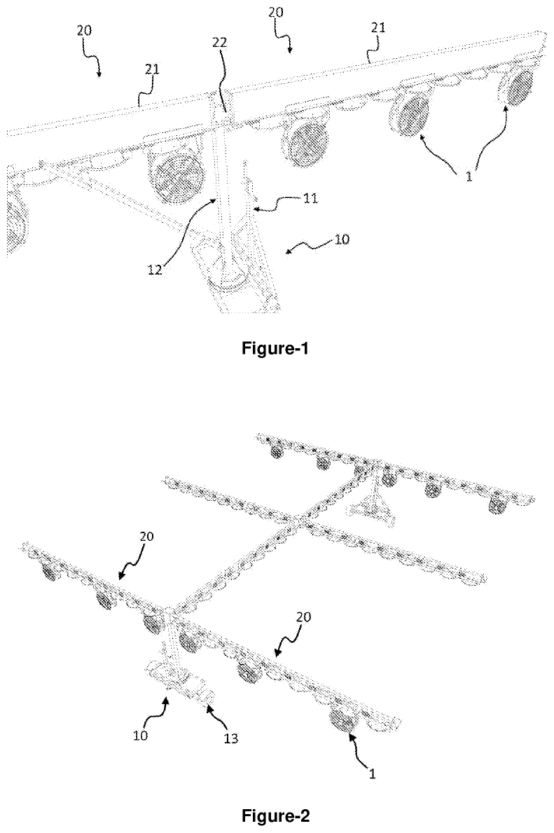

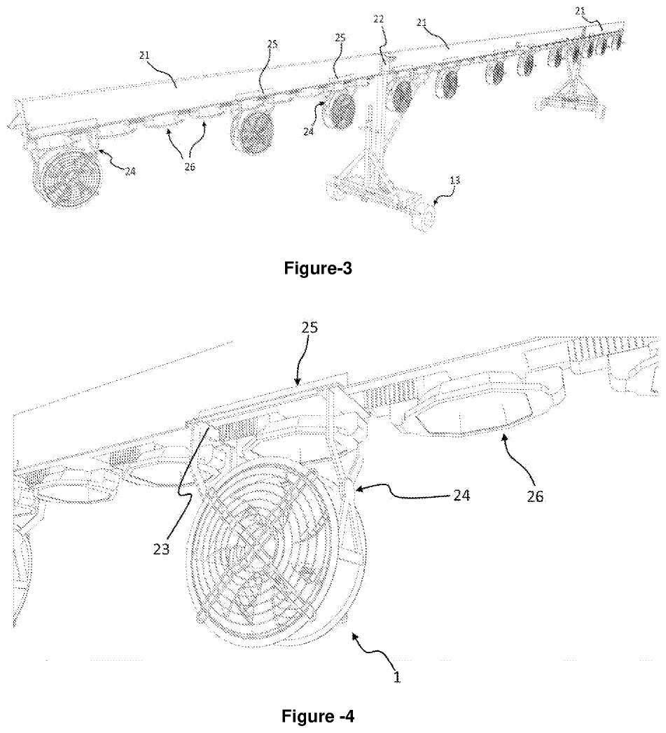

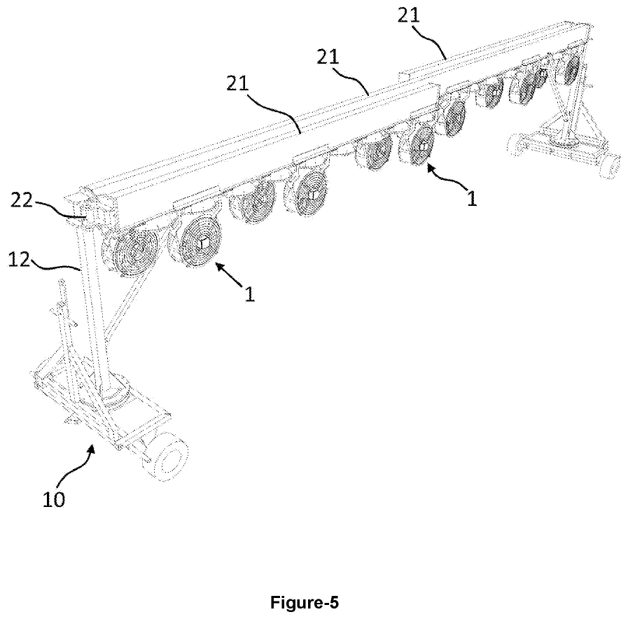

The ventilation system according to the present invention is comprised of fans (1) which are suspended from the ventilation units (20) which are mounted onto a mobile carrying trolley (10), as shown in FIG. 1. The number of fans (1) is determined according to the requirement of the stadium. When they operate simultaneously, these fans (1) which are attached to the support beams (21) of the ventilation units (20) provide for fresh air to come onto the grass by replacing the air accumulated on the natural grass field. Unlike the fans with high motor power located at the sides of the field in the current art, these provide that the air on the surface of the field is removed by a sweeping effect. Three ventilation units (20) which are drawn to their positions in the field by the towing arm (11) cover the short edge of the football field with the arms that are opened by the virtue of the hinges (22). In addition to this, the arms that are support beams (21) by the said hinge can be shifted into a position as seen in FIG. 5 to occupy less space with the purposes of storage or moving. By this way, the ventilation units (20) that are no longer used will be towed to the storage area. Optionally or depending on the capacity, motors can be attached to the fan trolleys. This way, these units can be moved remotely by a remote controller under motor control.

One of the most significant advantages of the fans (1) which are included in the ventilation system of the invention is that, they can be attached to any type of daylight units (known as Growlight units, UV devices, grass maintenance lamps, etc.) by the fan suspension brackets (23) and fan connection fixtures (24). In case the structure of the support beam (21) is a truss or a profile with special section, it can be made suitable for the ventilation units by different types of connection fixtures.

The weights of the ventilation units (20) are in a manner that would not cause harm to the grass. In addition to that, by the wheel (13) structures which are designed in accordance with the grass field, they can be used at every point of the field without applying pressure. In the current conventional system, there is a requirement of using large and strong fans at the side of the field; however, it is possible to reach every point in the field by the present invention.

The ventilation system of the invention enables the pulverizator system to be integrated by the virtue of the pulverizator connection (25) and therefore enables the application of the required liquids and gases during the maintenance of the grass. In addition to that, the ventilation fans (1) have a structure that is suitable to be suspended from the daylight units that are used in the field. The existing lamps and fixtures (26) on these units can be used simultaneously with the fans (1). A field watering system also can be installed as integrated to the fan carrier trolleys. By this way, the moisture and water need of the field can be provided without moving the fan trolleys.

1. A ventilation system which provides for the removal of the air accumulated on the grass field surface from the grass by creating a sweeping effect by a fan in the playing fields such as stadiums with low air circulation and which provides the fresh air to be distributed onto the grass in a homogeneous manner, the ventilation system comprising:
at least one ventilation unit which provides the fans to be carried by suspension,
at least one carrying trolley which enables the at least one ventilation unit from which the fans are suspended to be mobile,
at least one support strut which serves as a support between the at least one carrying trolley and the ventilation unit and which enables the fans that are suspended from the ventilation unit to operate at a certain height from the field.

2. A ventilation system according to claim 1, comprising a towing arm which provides for the pushing, pulling and guiding of the said carrying trolley and attaching the carrying trolley onto a vehicle when needed.

3. A ventilation system according to claim 1, comprising wheels which enable the carrying trolley to be moved by the said towing arm, which is located under the carrying trolley and which is suitable for the grass field surface.

4. A ventilation system according to claim 1, comprising a support beam which forms the frame of the said ventilation unit, which is formed of a single profile or a truss system and onto which the fans are mounted by suspension.

5. A ventilation system according to claim 1, comprising a hinge which folds at the point where the support strut and the support beam are coupled to each other and enables the ventilation units to occupy less space and therefore enables them to be stowed away or be carried easily.

6. A ventilation system according to claim 1, comprising a fan suspension bracket which creates the space between the ventilation fans and the support beams and also enables the vertical orientation adjustment of the fans to be made.

7. A ventilation system according to claim 1, comprising a fan connection fixture which enables the ventilation fans to be attached to any type of daylight units.

8. A ventilation system according to claim 1, comprising a pulverizator connection which enables the mounting of pulverizators, which provide the application of various liquids and gases required by the natural grass field.
